(19) United States
(12) Patent Application Publication
(10) Pub. No.: US 2023/0015022 A1
(43) Pub. Date: Jan. 19, 2023

(54) METHOD FOR SECURING A SECURITY DOCUMENT AND SECURITY DOCUMENT OBTAINED WITHI THIS METHOD

(71) Applicant: THALES DIS FRANCE SAS, MEUDON (FR)

(72) Inventors: Taru SYRJANEN, VANTAA (FI); Kristian LAPPALAINEN, ESPOO (FI); Jari HERLIN, SIPOO (FI); Pia VALKEINEN, NUMMINEN (FI)

(73) Assignee: THALES DIS FRANCE SAS, MEUDON (FR)

(21) Appl. No.: 17/783,099

(22) PCT Filed: Dec. 4, 2020
(86) PCT No.: PCT/EP2020/084622

§ 371 Date: Jun. 7, 2022

(30) Foreign Application Priority Data
Dec. 10, 2019 (EP) 19306615.6

(51) Int. Cl. B42D 25/455; B42D 25/36; B42D 25/24

(52) U.S. Cl. CPC B42D 25/455; B42D 25/36; B42D 25/24

(57) ABSTRACT

Provided is a method for securing a security document comprising at least personal data pages and a cover sheet placed outside the personal data pages, the method comprising, during security document manufacturing, a step of stitching the personal data pages and the cover sheet together by means of an upper thread and a lower thread interlaced together and a step of treating at least a part of the stitching with ultrasonic welding so as to structurally modify the thread.

### FIELD OF THE INVENTION

The invention relates to a method for securing security document in order to prevent access to the stitching thread of the security document when said security document is stitched. The invention relates also to a security document, such as a passport booklet, obtained with this method.

The invention finds applications in the security field and, in particular, in the field of security documents having the form of booklets containing each one several pages, like passport booklets.

### BACKGROUND

Security documents such as passport booklet are documents issued by a state to allow its citizens to travel abroad. These security documents, and passports in particular, are generally made up of various elements bound together as securely as possible in order to allow its holder to travel freely between states. They provide positive assurance that the identity is real and the person holding the document is correctly entitled to travel or enter a state. Lack of assurance based on poor quality of a document causes the traveller inconvenience as receiving states do not trust the document and conduct more checks or may impose visa regulations on the holder.

Passport booklets include generally a lot of security elements - such as guilloches, holograms, personalized markings, RFID chip, etc. - that allow an authentication of the passport holder. All the security elements are distributed in one or several pages of the passport booklet. However, passport booklets are the subject of numerous forgeries and counterfeits, notably by manipulation of the data contained in the pages. Most of the access to the data page(s) have security surrounding them in order to prevent this happening, mainly associated with the hinge technology. Indeed, forgers often try to detach the data page(s) from the rest of the booklet in order to insert counterfeit page(s).

To prevent these counterfeit and forgery activities, integrity in the booklet is a requirement by most states. Integrity preservation consists for example of preventing the access to the hinge, in particular to the stitching thread when the booklet is stitched. Indeed, as shown on FIG. 1, a passport 100 generally comprises a cover sheet 110 and personal data pages 120 stitched together, the cover sheet being attached outside pages 120. The cover sheet 110 comprises generally one or several end paper sheet(s) 112 and one cover material sheet 111 attached, for example glued, together in order to protect the stitching of the passport booklet.

As represented in the cross-sectional view of FIG. 2, the personal data pages 120 comprise generally several paper data pages 121, like visa pages, and one or more bio data page(s) 122 incorporating personalized data relative to the holder and security elements such as OVI® patch, hologram, ghost photo, guilloches, etc. In the example of FIG. 2, the passport booklet 100 comprises two bio data pages : a first bio data page 122 in the form of a PC (polycarbonate) data page in which specific data relative to the holder and/or security elements are incorporated and a second bio data page 123 in the form of a paper data page in which specific data relative to the holder and/or security elements—similar or different from these of bio data page 122—are incorporated. The first and second bio data pages 122, 123 are both sewn to the paper data pages 121 by means of the central stitching 130. Thus, the stitching 130—called also sewing line—constitutes a central hinge allowing assembling of all the pages and opening/closing of the passport booklet.

In the field of security documents, it is desirable to reduce the scope for fraudulent alteration of the document by ensuring that the document cannot readily be dismantled or that any dismantling attempt be visible. Indeed, it happens that forgers open the stitching from the central page of the passport booklet, keep the thread unharmed and re-use it after having modified pages of said passport booklet. In particular, when the stitching joining the plurality of pages to one another of the security document is formed by an upper and a lower threads of same material (synthetic fibers or natural fibers) or of different material (for example one thread is in synthetic fibers and the other thread is in natural fibers), it is known that the stitching can be opened without any tamper evidence. Several methods of preventing access to the sewing line have been implemented on passport booklets.

One of the known methods consists of including plastic particles dispersed among the fibers of the threads used in the stitching and coating the outer surface of personal data pages with a fusable thermoplastic material. Once stitched, the assembly is clamped and heated with welding electrodes which fuse the threads and pages together at their crossing locations.

Another known method consists of adding UV curing adhesive on top of the stitching. Depending on the used glue and type of stitching, UV glue bonds the thread slightly onto paper, spine tape and itself. Additionally, it makes the thread stickier.

Hence, the thread is more tedious to remove and, in case of opening attempt, the thread is cut or frayed, making the tampering visible. UV gluing has known disadvantages: it requires an addition of a new chemical component (HSE topics) and it may cause staining of the security paper. In case the UV glue and cover glue are not fully compatible, UV glue addition causes tenting in the spine of the booklet.

Another known method to seal the stitching is to use thread with thermoplastic (polypropylene) components. In that method, the stitching is heated so that part of the thread melts.

To further protect against fraudulent alteration of such security documents, or the making of counterfeits, security documents typically also include a number of security elements such as fine line printing, intaglio printing, watermarks, optically variable elements such as holograms or Kinegrams™, perforations, laser marking and other such features which are difficult to modify and/or reproduce.

However, there is a constant need to provide new and superior security features as the technology available to potential counterfeiters advances.

### SUMMARY OF THE INVENTION

In response to the above formulated problems of thread opening of the stitching by forgers, the applicant is proposing a method for securing passport booklets and other security documents by structurally modifying the thread.

According to a first aspect, the invention concerns a method for securing a security document comprising at least personal data pages and a cover sheet placed outside the personal data pages, the method comprising, during security document manufacturing, a step of stitching the personal data pages and the cover sheet together by means of an upper thread and a lower thread interlaced together. The method is characterized in that it comprises a step of treating at least a part of the stitching with ultrasonic welding so as to structurally modify the thread.

Such a method allows, among other advantages, to secure the stitching of passport booklet so as said stitching cannot be opened keeping the threads unharmed.

In the description, the expressions “passport” or “security document” will designate in the same manner any document having the form of a booklet and containing security data specific to its holder.

In the description, the expressions “stitching”, “sewing line” or “stitching line” will indifferently be comprised as a set of sewing points by which several pages are assembled together. As understood from the description below, a stitching comprises of a consecutive line of stitches that are formed of an upper thread and a lower thread being interlaced with each other.

According to some embodiments, the step of treating the stitching with ultrasonic welding is implemented after the step of stitching the personal data pages and the cover sheet.

According to some other embodiments, the step of treating the stitching with ultrasonic welding is implemented at the same time as the step of stitching the personal data pages and the cover sheet.

Advantageously, at least one of the upper and lower threads comprises synthetic fibers.

According to some embodiments, at least the upper thread comprises synthetic fibers. The other thread can either comprise synthetic fibers or natural fibers.

According to one or more embodiments, the security document comprises a spine tape extending centrally between top and bottom of the security document, said spine tape comprising synthetic fibers adapted to be joined to the synthetic fibers of at least the upper or the lower thread when ultrasonic welded.

According to one or more embodiments, the ultrasonic welding is applied by means of an ultrasonic welding apparatus comprising a sonotrode placed over the stitching.

According to a second aspect, the invention concerns a security document comprising at least:
personal data pages, and
a cover sheet placed outside the personal data pages and stitched with the personal data pages by means of a stitching (130) comprising an upper thread and a lower thread interlaced together, characterized in that at least a part of the stitching is secured by the method defined above.

According to one or more embodiments, the security document comprises a spine tape extending centrally between top and bottom of the security document and at least a part of the stitching is joined to said spine tape.

### BRIEF DESCRIPTION OF THE DRAWINGS

A detailed description of some preferred embodiments is set forth herein below with reference to the following drawings, in which:

FIG. 1, already disclosed, is a general view of a passport booklet according to the prior art;

FIG. 2, already disclosed, is a cross-sectional view of a passport booklet;

FIG. 3 is an enlarged schematic view of the upper and lower threads in a stitching portion of a passport booklet;

FIG. 4 is a schematic top view of a passport booklet during the treatment step of the method according to the invention;

FIG. 5 is a schematic cross-sectional view of the sewing line of a passport booklet during the treatment step of the method according to the invention;

FIG. 6 is a schematic view of a sewing line of a passport booklet after dismantling attempt.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example” means that a particular feature, structure, or characteristic described is included in at least one embodiment described herein and does not imply that the feature, structure, or characteristic is present in all embodiments described herein.

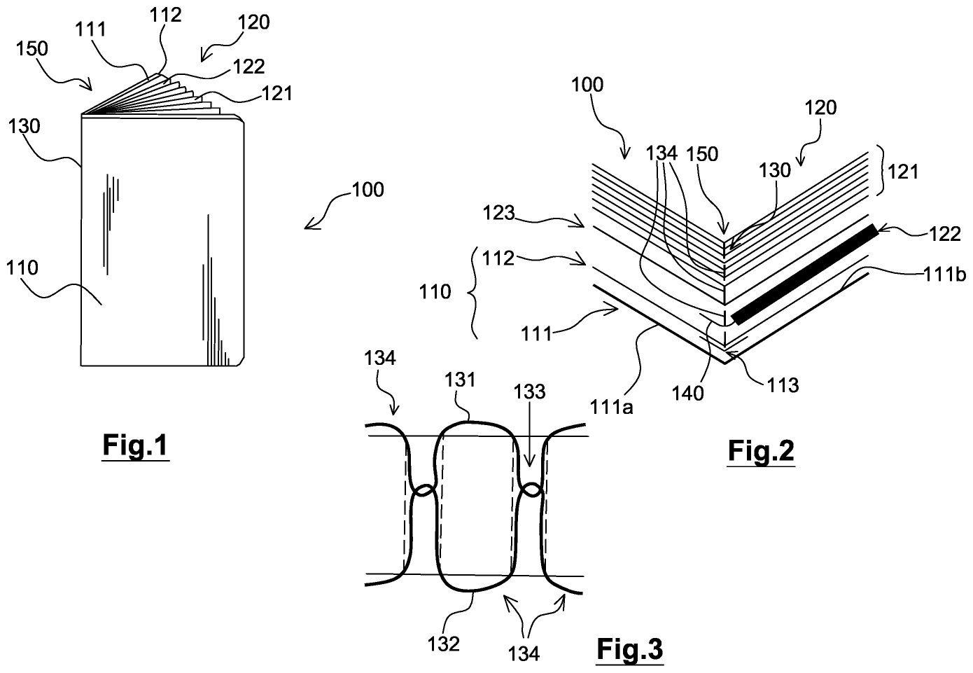

The invention is proposing a method for modifying the stitching of a passport booklet in such a way that the stitching cannot be opened without harming the thread. This method may be implemented in any passport booklet including examples of passport booklet of the type shown in FIG. 1 and FIG. 2 or described in the present description. This method proposes to structurally modify at least one of the threads of the stitching line of the passport booklet with an ultrasonic welding treatment, the treatment being applied at any time after the stitching is done, for example at the end of the passport booklet manufacturing. This method is intended to secure a security document such as a passport booklet by protecting the stitching or sewing line. The passport booklet described herein can be applied to any form of multi-page security document. In particular, the method according to the invention can be implemented in a passport booklet such as the passport represented in FIGS. 1 and 2.

In the description below such documents will generally be referred to as “passport booklets” or “booklets” or “passports” although it will be understood that this refers to generally any structure in which multiple pages are joined to one another. The term “page” generally indicates a portion of a sheet material such as paper, polymer or a laminate. Pages are generally moveable relative to one another, although this is not essential. It is envisaged that the security document may be used in any form of multi-page security document, including passports, bank books, cheque books, ticket books, an identification booklet or other type of security document that can employ one or more of the security concepts described herein.

As represented on FIG. 2, and already disclosed, a passport booklet 100 according to the invention comprises a cover sheet 110 and personal data pages 120 attached together, the personal data pages 120 being stitched together inside the cover sheet 110. In the example of FIG. 2, the cover sheet 110 comprises one end paper sheet 112 and one cover material sheet 111 (including a front cover 111a and a back cover 111b) typically affixed to the stitched sheets by adhering it to said end paper sheet 112.

The personal data pages 120 comprise several paper data pages 121 and bio data pages 122, 123 stitched together for forming a booklet. The bio data pages 122, 123 may be sewn to the paper data pages 121, for example through a hinge 140. The personal data pages 120 are also stitched to the end paper sheet 112 by means of a stitching 130.

The stitching 130 assembling personal data pages 120 and end paper sheet 112 extends between top and bottom of the booklet, for example along or in parallel to a center fold line 150 which acts as a spine for the booklet. All the pages of the passport are folded relative to the center fold line 150, along or in parallel to the sewing line 130, this folding creating an array of aligned and nested fold lines.

According to the invention, the stitching line 130 of the passport booklet 100 comprises several consecutive stitches 134, as represented in detail in FIG. 3. In particular, FIG. 3 represents a part of a booklet sewing 130 with a few stitches 134 set consecutively to each other. The sewing line 130 is obtained by means of an upper thread 131 and a lower thread 132 interleaved together so as to create stitches 134 with interlacing 133 there between. Each interlacing 133 allows locking of the upper thread 131 by the lower thread 132, and inversely.

According to some embodiments, at least one of the upper thread 131 and lower thread 132 is in synthetic fibers, the other being either in synthetic fibers or natural fibers. In an example, both threads comprise synthetic fibers. In another example, only the upper thread 131 comprises synthetic fibers, the lower thread 132 comprising natural fibers. The skilled man would understand that a thread said “in synthetic fibers” may comprise only synthetic fibers or a mixing of synthetic and natural fibers insofar as it comprises more synthetic fibers than natural fibers. Similarly, the skilled man would understand that a thread said “in natural fibers” may comprise only natural fibers or a mixing of synthetic and natural fibers insofar as it comprises more natural than synthetic fibers.

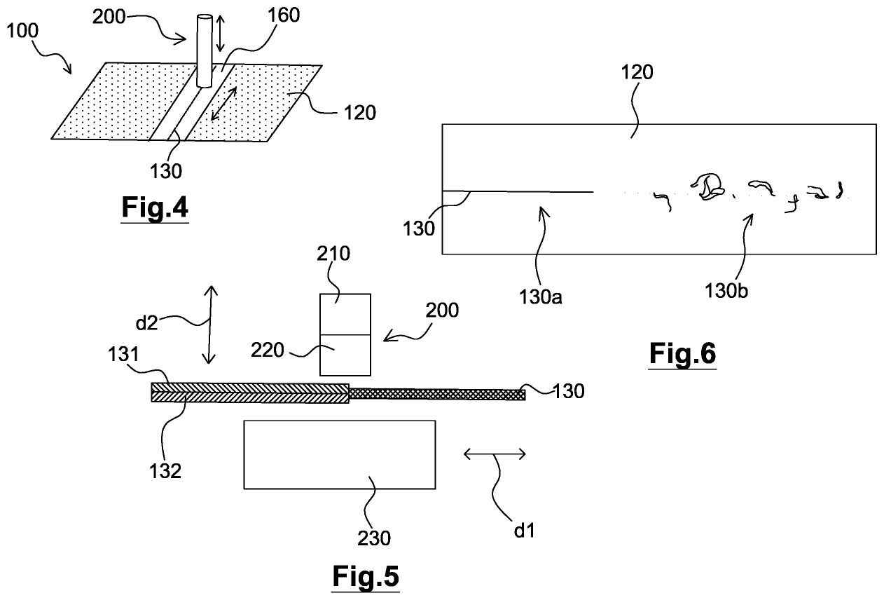

FIG. 4 depicts the formation of the secured stitching 130 according to the invention. The stitching line 130, or a portion of said stitching line 130, is secured using an ultrasonic welding apparatus 200 placed over said stitching 130. The ultrasonic welding apparatus 200 placed over/under the stitching 130 applies both ultrasonic energy and pressure to the assembled upper and lower threads, 131, 132 to structurally modify at least one of the threads. For example, the ultrasonic treatment allows to both threads to be fused together. In that example, the ultrasonic welding allows a fusion of the threads to be joined in order to assemble them into a single coherent line. In another example, where a centerfold paper in plastic material is inserted inside the booklet, the ultrasonic treatment allows the paper material to be fused with one of the threads. If the booklet comprises a spine tape, then the ultrasonic treatment allows to one of the threads to be fused with the spine tape. In yet another embodiment, the ultrasonic treatment allows to one of the threads to be structurally modified. Depending on the embodiment, in case of thread opening attempt by forgers, either the thread breaks or the booklet is damaged.

A schematic view of an ultrasonic welding apparatus according to some embodiments is represented in FIG. 5. This ultrasonic welding apparatus 200 comprises:
a support 230, such as an anvil, against which the threads 131 and 132 are disposed;
a high frequency sound generator 210—called more simply generator—which generates ultrasonic energy, or ultrasounds. The ultrasounds are mechanical vibrations at a frequency of about 16 kHz or above; and
a sonotrode 220 which transmits the ultrasounds from the generator 210 to the threads 131, 132 to be welded.

In other embodiments, the ultrasonic welding apparatus is a handheld equipment wherein the support 230 is independent from the sonotrode 220 and the generator 210, said generator and sonotrode being connected together.

As in any known ultrasonic welding apparatus, the pieces to be welded—here threads 131 and 132 - are kept under pressure between the support 230 and the sonotrode 220 and ultrasonic signals are briefly emitted by the high frequency sound generator 210. The sonotrode 220 can be a single-head or a multi-head sonotrobe. The support 230 and the sonotrobe 220 can be stationary or movable according to one or more directions. A first direction, represented by the arrow d1, enables moving of the threads in respect to the sonotrode. A second direction, represented by the arrow d2, is different from the first direction d1, for example perpendicular to said first direction. The moving according to the second direction enables pressure of the threads during welding and release of the threads after welding. In the example of FIG. 5, the support 230 is selectively movable according to the first direction d1, enabling threads moving in respect to the sonotrode 220 and according to the second direction d2, enabling pressure of the threads against the sonotrode 200.

As disclosed above, heat required for welding is applied to the threads 131, 132 by the ultrasonic energy provided by the generator 210 and supplied by the sonotrode 220. The energy required for the welding depends on the characteristics of the material to be welded. Taking into account that the frequency of the equipment is fixed, suitable welding parameters are found by optimizing the amplitude, time, and pressure. For example, the ultrasonic welding apparatus may generate an ultrasonic energy at 40 kHz with an amplitude range from 70 to 99%.

As described above, the threads 131, 132 are securely bound by the ultrasonic welding process so that they cannot be disassembled without providing visual indication of tampering. An example of a stitching line 130 as obtained after ultrasonic welding treatment is represented on FIG. 6. In particular, FIG. 6 shows a first part 130a of a stitching line 130 in which the line is regular like in a decent passport booklet.

FIG. 6 shows a second part 130b of the stitching line 130 which, on the opposite to the first part 130a , has undergone a dismantling attempt. Indeed, after opening attempt, the stitching line 130 obtained with the method of the invention comprises several cutting and/or fraying which are visible by any security agent and constitute clear attempted infringement.

According to some embodiments, the cover sheet 110 comprises a spine tape 113 inserted between the end paper sheet 112 and the cover material sheet 111. The spine tape 113 extending between top and bottom of the booklet is generally glued and sewn with the booklet. The spine tape 113 can extend on the total height of the booklet or on only a portion of the height of the booklet. According to one embodiment, the spine tape 113 comprises synthetic fibres, adapted for joining with the synthetic thread (for example the upper thread 131) by ultrasonic welding. Thus, in such an embodiment, the upper thread 131 and/or the lower thread 132 is ultrasonically welded with the spine tape 113 so as to make even more difficult any cutting attempt of the stitching line 130.

Thus, the method as disclosed above makes the stitching tamper evident without complicated, visible changes to the thread or paper. It prevents the re-use of the thread after tampering.

The treatment by ultrasonic welding as disclosed above has not only the advantage to make passport booklet stitching tamper proof, but also to be a clean method requiring no supplemental using of chemical component, no supplemental application of adhesive, no protection of other parts of the pages, etc. Only classical components of a passport booklet are needed as well as the using of an ultrasonic welding apparatus. The method is thus cost efficient and ecological solution.

Further, ultrasonic welding is a fast industrial and robust process which does not interfere with the chemical sensitization of the security paper. In addition, no modification of usual manufacturing steps is needed, only a supplemental step of treatment by ultrasonic welding is necessary after the sewing process.

Even if, in the description above, the ultrasonic treatment is described as being implemented after the sewing process, it would be understood that the ultrasonic treatment can also be implemented simultaneously to the sewing process. In such an embodiment, the ultrasonic welding apparatus and the method for securing the booklet are identical to the previously described apparatus and method, except that the ultrasonic welding operation is executed together with the sewing operation.

While only some selected embodiments have been chosen to illustrate the present invention, it will be apparent to the skilled person from this disclosure that various changes and modifications can be made herein without departing from the scope of the invention as defined in the appended claims. The structures and functions of one embodiment can be adopted in another embodiment. Further, it is not necessary for all advantages to be present in particular embodiments at the same time.

1. A method for securing a security document comprising at least personal data pages and a cover sheet placed outside the personal data pages,
the method comprising, during security document manufacturing, a step of stitching the personal data pages and the cover sheet together by means of an upper thread and a lower thread interlaced together, wherein the method further comprises a step of treating at least a part of the stitching with ultrasonic welding so as to structurally modify at least one of the upper threads and the lower thread.

2. The method according to claim 1, wherein the step of treating the stitching with ultrasonic welding is implemented after the step of stitching the personal data pages and the cover sheet.

3. The method according to claim 1, wherein the step of treating the stitching with ultrasonic welding is implemented at the same time as the step of stitching the personal data pages and the cover sheet.

4. The method according to claim 1, wherein at least one of the upper and lower threads comprises synthetic fibers.

5. The method according to claim 4, wherein the upper thread comprises synthetic fibers.

6. The method according to claim 5, wherein the lower thread comprises natural fibers.

7. The method according to claim 6, wherein the security document comprises a spine tape extending centrally between top and bottom of the security document, said spine tape comprising synthetic fibers adapted to be joined to the synthetic fibers of at least the upper or the lower thread when when ultrasonic welded.

8. The method according to claim 7, wherein the ultrasonic welding is applied by means of an ultrasonic welding apparatus comprising a sonotrode placed over or under the stitching.

9. A Security document comprising at least:
personal data pages, and
a cover sheet placed outside the personal data pages and stitched with the personal data pages by means of a stitching comprising an upper thread and a lower thread interlaced together,
wherein at least a part of the stitching is secured.
during security document manufacturing, by stitching the personal data pages and the cover sheet together by means of an upper thread and a lower thread interlaced together, and
treating at least a part ot the stitching with ultrasonic welding so as to structurally modify at least one of the upper thread end lower thread.

10. The security document according to claim 9 comprising a spine tape extending centrally between top and bottom of the security document, wherein at least a part of the stitching is joined to said spine tape.
